(19) United States
(12) Patent Application Publication
(10) Pub. No.: US 2007/0133342 A1
(43) Pub. Date: Jun. 14, 2007

(54) Hand-held electric mixer or blender

(76) Inventors: Sergi Gili, Barcelona (ES); Mariano Penaranda, Barcelona (ES); Vicenc Safont, Barcelona (ES); Robert Rafols, Barcelona (ES); Alejandro Hernandez, Tarragona (ES)

Correspondence Address: FISH & RICHARDSON PC, P.O. BOX 1022, MINNEAPOLIS, MN, 55440-1022, US

(21) Appl. No.: 11/638,926

(22) Filed: Dec. 14, 2006

(30) Foreign Application Priority Data
Dec. 14, 2005 (DE) 10 2005 059 697.5

(51) Int. Cl. A47J 43/044; A47J 43/06

(52) U.S. Cl. 366/129; 366/344

(57) ABSTRACT

A hand-held electric blender or mixer has an electric motor that is accommodated in a housing and that serves for selectively driving different attachments, such as a whisk or kneading hook or an immersion blender. The hand-held blender or mixer has an actuating element that opens and closes a switch for switching the electric motor on and off. The switch can be operated in a temporary mode or in a continuous mode, depending on the respective attachment coupled to the appliance. An interlocking means is provided for the actuating element and is either engaged with a counterpart to the interlocking means or not, depending on the type of attachment coupled to the appliance.

### CROSS REFERENCE TO RELATED APPLICATION

This application claims priority under 35 U.S.C. §119(a) from German application serial number DE 10 2005 059 697.5, filed Dec. 14, 2005, the entire contents of which are hereby incorporated by reference.

### TECHNICAL FIELD

This invention relates to a hand-held electric blender or mixer having an electric motor that is accommodated in a housing and serves for selectively driving different attachments, such as a whisk or kneading hook or an immersion blender.

### BACKGROUND

German Patent No. DE 600 06 695 T2 describes a hand-held blender or mixer. This appliance serves for selectively driving at least one accessory blending device, for example a whisk, or an accessory mixing device that rotates at high speeds, e.g. an immersion blender. In this context, the term accessory blending device generally refers to an attachment such as a whisk or a dough kneader, while the term accessory mixing device refers to an attachment that rotates at high speeds, for example an immersion blender with rotating knives.

The hand-held mixer operates in the continuous mode when kneading or blending attachments are coupled thereto, but can only be operated in the temporary mode when an immersion blender is coupled to the appliance. This prevents the user from being injured by the knife blade in case the appliance is improperly handled, for example, if it unexpectedly falls out of the user's hand. In comparison with kneading or blending attachments, immersion blenders generally are only used for very brief periods of time such that a continuous actuation of the actuating element by the user is by no means unreasonable. However, when a kneading or blending attachment is used on the appliance, it is possible to operate the appliance in the continuous mode, such that the actuating element of the switch does not have to be continuously actuated with the user's thumb. The risk of being injured by kneading or blending attachments is not particularly high, even if the appliance is improperly handled, and for example, unexpectedly slides out of the user's hand, because these attachments do not feature any sharp-edged components as is the case with an immersion blender.

The appliance features a control lever that can be turned about a rotational axis, such that it can assume a stopped position, and several switched positions for the continuous operation of the motor. In addition, a coil spring is mounted concentric to the rotational axis of the control lever, and features a fixed end that is connected to the control lever, as well as a free end. The tension of the coil spring either acts upon the control lever, or not depending on the attachment that is coupled to and driven by the appliance. In the former instance, the control lever is automatically transferred into the off position under the influence of the spring force of the coil spring when the control lever is not actuated. In the latter instance, in which the spring force of the coil spring does not act upon the control lever, the control lever continuously remains in the respective switching position. The vibrations of the appliance may cause the switching position of the control lever to unintentionally change due to the lack of interlocking devices.

EP 1 092 379 A1 discloses another electric hand-held mixer for processing foods that features a switching means adjustably arranged on a housing. The switching means has different switching positions for activating the continuous mode and the temporary mode. The appliance further features two receptacles for holding various attachments, for example, a blending or kneading hook or an immersion blender. Two switching elements are provided, such that one switching element is assigned to the activation of the continuous mode and the other switching element is assigned to the activation of the temporary mode. Both switching elements, as well as a trigger element for ejecting an attachment held in one of the receptacles, are mechanically coupled to one another in such a way that only one of the two switching elements can be actuated at a time.

EP 529 266 B1 pertains to an electrically operated hand-held mixer for processing foods that features a manually actuated electric switching device for starting the electric motor. This switching device has one or more switching positions for the continuous mode of the electric motor, as well as at least one switching position in which the electric motor is only driven (temporary mode) as long as the switching device is manually actuated. The mixer also features several coupling devices that serve for holding, and for driving various attachments that can be coupled to the appliance, for example, kneading hooks, whisks, or an immersion blender featuring a rotating knife. The hand-held mixer features a means for ensuring that a connection between the electric motor and the power supply is not made despite the activation of the switching positions for the continuous mode, after an immersion blender or other knife-like attachments is attached to the coupling device. The electric motor remains connected to the power supply if the switching position is manually activated in accordance with the temporary mode. Among other things, the means consist of an electric switch that is closed when there is no attachment inserted into the coupling devices provided for the immersion blender or another knife-like attachments. The switch lies in the circuit for the continuous mode of the electric motor and is opened when the immersion blender or another knife-like attachments is inserted into the coupling device provided for this purpose. In this case, the switch is opened during the coupling of the immersion blender or another knife-like attachment before its mechanical connection with the corresponding coupling device is produced. This coupling device is accessible from outside through an opening that is arranged on the motor housing and can be closed with a cover. The cover is automatically transferred into the closed position by the force of a spring. The electric switch in the circuit for the continuous mode of the electric motor is only opened by the cover when it is situated in its open position. After coupling an immersion blender or a similar knife-like attachment to the coupling device and opening the cover, a stop realized on the attachment holds the cover in the open position against the force of the spring.

A hand-held electric blender and mixer is described in DE 696 00 634 T2. The hand-held electric blender has an opening in the housing that serves for coupling the respective attachments and that can be closed by means of a displaceable slide. A similar protection against the admission of dirt into the interior of the housing of kitchen appliances is also described in DE 60004240 T2, wherein a pivoted double cover closes an opening for coupling attachments to the appliance. This double cover is held in the closed position by the prestresses of a spring. When an attachment is inserted, the double cover is pivoted from the closed position into an open position by the attachment against the prestress of the spring. After the attachment is decoupled, the opening in the housing is automatically closed again by the double cover. At this point, it should be noted that all publications cited with reference to the state of the art are hereby expressly incorporated by reference into the disclosure of the present application with respect to a temporary operation/continuous operation in dependence on the attachment used as well as with respect to the closing of openings in the housing by means of slides or covers. This applies analogously to the applications and intended uses of such hand-held electric kitchen appliances.

### SUMMARY

One aspect of the present invention features a hand-held electric food processing appliance having a simple constructive means that allows the appliance to operate in the temporary mode and in the continuous mode, depending on the respective attachment used. Attachments coupled to the appliance that feature a knife or another sharp-edged object can only be operated in the temporary mode, while other attachments without any sharp-edged objects, or that need to remain activated over an extended period of time, can be operated in the continuous mode. In the temporary mode, an actuating element of a switch needs to be continuously actuated because the switch is automatically transferred into the off position, switching the appliance off when the actuating element is not actuated. In the continuous mode, the actuating element can transfer the switch into a switching position in which the appliance is switched on without the actuating element being continuously actuated by the user. According to a secondary aspect, it should also be ensured that currently unneeded openings in the housing used for coupling the different attachments to the appliance are reliably and permanently closed, such that soiling of the appliance is largely prevented.

Another aspect of the invention features a hand-held electric blender or mixer having an interlocking means of the actuating element of the switch that is either engaged, or not, with a counterpart, depending on the type of attachment coupled to the appliance. For example, if an attachment with a knife or a similar sharp-edged object is coupled to the hand-held blender, the interlocking means of the actuating element is not engaged with the corresponding counterpart, such that the actuating element can only switch on the electric motor in the temporary mode and the switch automatically switches off the appliance if the actuating element is not actuated. However, when kneading hooks or whisks are coupled to the appliance, the interlocking means of the actuating element of the switch is engaged with the corresponding counterpart, such that the actuating element, and therefore the switch, can be activated in the continuous mode. Thus, the appliance can remain in the switched-on state without having to continuously actuate the actuating elements until the user transfers the actuating element into an off position, opening the switch and switching the hand-held blender off.

In some embodiments, the actuating element is subjected to the prestress of a spring that tends to transfer the actuating element into the open position of the switch. This means that the actuating element is pre-programmed for the temporary mode if the interlocking means and the corresponding counterpart are not engaged with one another, such that the actuating element automatically transfers the switch into the off-position when it is not actuated by the user. In this respect, a switch is provided for a household appliance that can be operated with a single actuating element, such that the actuating element can be used for activating the temporary mode or the continuous mode, depending on whether or not the interlocking means are engaged with the corresponding counterpart.

In some embodiments, the actuating element consists of a rocker that actuates a switching contact of the switch. If the actuating element is acted upon on one side similar to a rocker, a switching contact of the switch is brought in electrically conductive contact with the corresponding counterpart such that the circuit is closed. This switching contact that acts upon the actuating element may, however, also be realized in the form of a spring leg or similar elastic element that generates the prestress exerted upon the actuating element.

In some embodiments, the interlocking means of the actuating element can be realized in the form of a groove and/or tongue arrangement. In this arrangement, the counterpart to the interlocking means engage into the grooves, and between the tongues in order to ensure the defined positioning of the actuating element in the activated continuous operating mode of the switch.

The counterpart to the interlocking means can be a peg, a mandrel, a pin or similar finger that is subjected to the prestress of a spring. This finger engages into the interlocking means of the actuating element in order to fix the actuating element in the selected switching position.

The counterpart to the interlocking means can be supported, for example, on a carrier or a slide such that it can be adjusted relative to the actuating element and its interlocking means, respectively. Consequently, it is possible to position the counterpart to the interlocking means either in the region of the interlocking means or outside this region. The positioning of the counterpart to the interlocking means depends on the type of attachment coupled to the appliance.

The actuating element can be arranged such that it can be pivoted about a pivoting axis similar to a rocker. The counterpart to the interlocking means or its carrier, respectively, is supported such that it can be displaced in the direction of the pivoting axis. This makes it possible to displace the counterpart to the interlocking means and the slide carrying said counterpart along the actuating element, for example along its pivoting axis, such that the counterpart to the interlocking means either engages with the interlocking means of the actuating element, or not depending on the attachment coupled to the appliance.

In this case, the interlocking means can be arranged on the actuating element by means of a first section, for example, of an inner wall, and the first section is followed by a second section without interlocking means. During the displacement, the counterpart to the interlocking means is therefore displaced either to the first section featuring the interlocking means, or the second section without interlocking means depending on the type of attachment coupled to the appliance. The actuating element is in the position that corresponds to the temporary mode went the counterpart to the interlocking means is situated adjacent to the second section. However, if the counterpart to the interlocking means is arranged opposite the first section featuring the interlocking means, the actuating element can also be operated in the continuous mode.

Various attachments may be inserted into different openings of the housing, particularly adjacent openings, and driven by the electric motor, if so required, via a gear. Two openings for whisks are arranged in a bottom plate of the housing. Another opening arranged directly adjacent to these openings serves for coupling other attachments to the appliance, for example, an immersion blender with knife attachment.

In some embodiments, the appliance has an adjustable sliding part that is assigned to at least one of the openings. The sliding part can be assigned, and also be referred to as an ejector plate, to one or both openings for the kneading hooks or the whisks. The sliding part serves for detecting which of the different attachments is currently coupled to the appliance. The actuating element or the switch is either operated in the temporary mode or in the continuous mode depending on whether or not the adjustable sliding apart is adjusted by coupling a corresponding attachment to the appliance.

In some embodiments, the sliding part is characterized in that it can be displaced from an initial position into an end position when an attachment is coupled to the appliance by using the assigned openings. For example, if the kneading hooks or whisks are coupled to the appliance, the sliding part is displaced from the initial position into the end position and the engagement between the interlocking means and the counterpart is ensured.

The sliding part preferably is kinematically coupled to the counterpart to the interlocking means, wherein a lever, particularly a rocker-type lever, is arranged between the sliding part and the counterpart to the interlocking means or the carrier, respectively, or the slide. This blender transmits the movement of the sliding part to the counterpart to the interlocking means and the slide carrying this counterpart, respectively. The adjusting devices of the sliding part and the counterpart to the interlocking means can form an angle of approximately 90° in this case.

The sliding part may serve for distinguishing the respective attachment coupled to the appliance. The sliding part or ejector plate can also be transferred from the end position into the initial position, in which the corresponding attachment(s) is/are decoupled from the appliance, by means of an ejector button. In addition, the prestress of a spring automatically transfers the counterpart to the interlocking means and the slide carrying this counterpart into the position in which the interlocking means and the corresponding counterpart are disengaged.

The ejector button is essentially arranged directly adjacent to the actuating element and protrudes farther from the housing than the actuating element. If the appliance accidentally slides out of the user's hand, this measure ensures that the ejector button is initially actuated and decouples the respective attachments, and that the actuating element or the switch is transferred into the temporary mode such that the possibly still operating appliance is automatically switched off.

Independent of the change-over of the switch between the temporary operating mode and the continuous operating mode, in some embodiments the different openings in the housing used for coupling the various attachments to the appliance can be selectively closed by means of a sliding plate. This measure ensures that the respective openings that are currently not occupied by an attachment remain closed, such that moisture and dust cannot be admitted into the interior of the appliance housing.

The sliding plate can be adjusted between a first end position and a second end position, in which either the one or more openings for one attachment or the other opening for the other attachment is/are closed. This ensures that all openings of the housing used for coupling the attachments to the appliance are either closed by the attachments themselves or by the sliding plate.

The sliding plate can be supported in a displaceable fashion on a housing bottom, particularly an inner wall of the bottom. The sliding plate can have elastic interlocking arms for fixing the sliding plate in the end positions in a defined fashion due to the engagement of the interlocking arms with the housing bottom. The sliding plate can be adjusted between the end positions by means of a protruding handle. In some configurations, the housing features an opening that makes it possible for one hand of the user to reach through. The opening is preferably formed by arms as well as a web connecting these arms.

Other aspects, features, and advantages will be apparent from the following detailed description, the drawings, and the claims.

### DESCRIPTION OF DRAWINGS

The figures show:

FIG. 1, a schematic side view of a hand-held mixer with a first attachment coupled thereto, for example, a kneading hook or two whisks;

FIG. 2, the hand-held mixer according to FIG. 1 and an immersion blender with rotating knife coupled thereto;

FIG. 3, an embodiment of the actuating element with interlocking means and the corresponding counterpart as well as the adjustment of the counterpart, and

FIG. 4, an enlarged exploded view of a detail of FIG. 3;

FIGS. 5A-C and 6A-C show respective comparisons of the embodiment according to FIG. 3 in the starting position 40 and in the end position 41, wherein the starting position represents the situation in which an immersion blender is coupled to the appliance rather than attachments (temporary mode) and the end position represents the position in which kneading hooks or whisks are coupled to the appliance, and wherein FIGS. 5A and 6A respectively show a side view of the device, FIGS. 5B and 6B show a top view of the device with removed actuating element and FIGS. 5C and 6C show a section through the actuating element and the counterpart to the interlocking means on the slide;

FIGS. 7A-B and 8A-B show perspective side views of the motor with a gear flanged thereon in order to elucidate the coupling points for the various attachments;

FIG. 9 shows the housing bottom with the sliding plate removed therefrom, and

FIGS. 10A-C and 11A-C show the first and the second end position of the sliding plate that is displaceably guided on the housing bottom, wherein FIGS. 10A and 11A respectively show a view of the inner wall of the housing bottom, FIGS. 10B and 11B show a section along the line A-A in FIGS. 10A and 11A, and FIGS. 10C and 11C show a bottom view of the housing bottom.

Like reference symbols in the various drawings indicate like elements.

### DETAILED DESCRIPTION

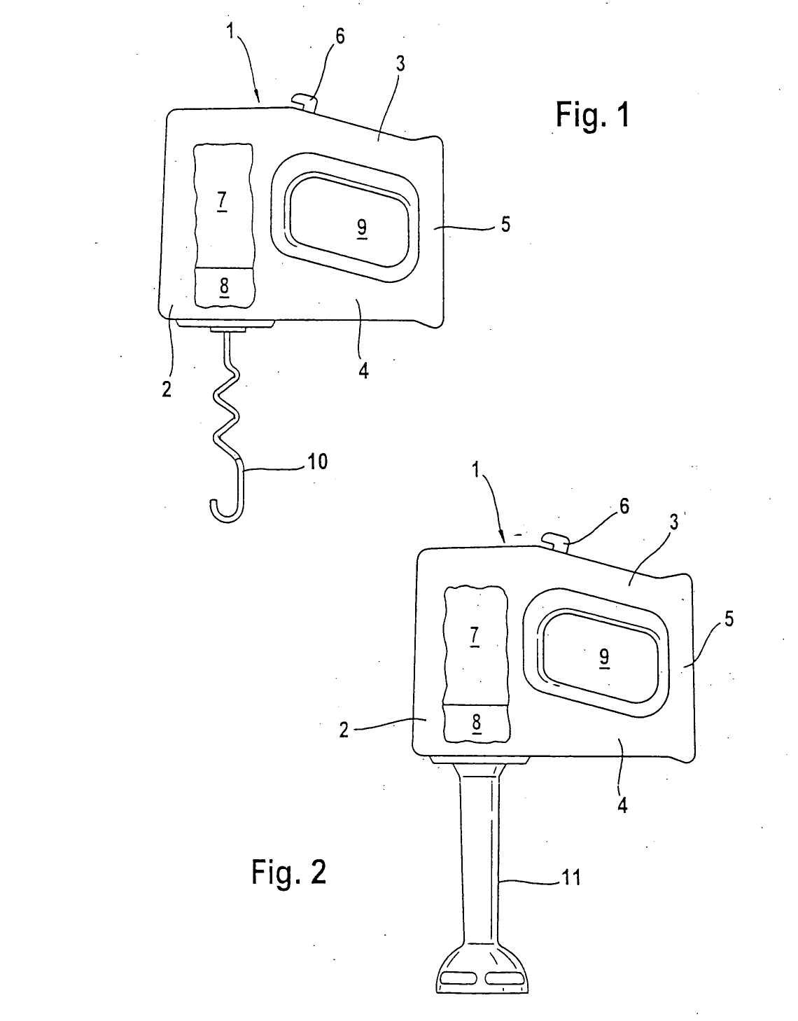

FIG. 1 shows a hand-held mixer 1 that essentially consists of a housing 2 provided with an electric motor 7 as well as upper and lower arms 3, 4 that are connected to one another by a perpendicularly extending web 5 on their free ends. The free space created by the housing 2, the arms 3, 4 and the web 5 forms an opening 9 for accommodating a hand of the user, for example, when the hand partially encompasses the upper arm 3 in order to manipulate the hand-held mixer. An actuating element 6 for switching the electric motor 7 on and off is arranged on the upper side of the housing. In FIG. 1, a kneading hook 10 or two whisks 10 are or can be respectively coupled to the hand-held mixer 1. In FIG. 2, the hand-held mixer 1 is coupled to an immersion blender 11 that typically features a rapidly rotating knife in the region of the lower bell in FIG. 2. FIGS. 1 and 2 schematically show that a gear can be arranged between the electric motor 7 and the coupling point for the attachments 10, 11.

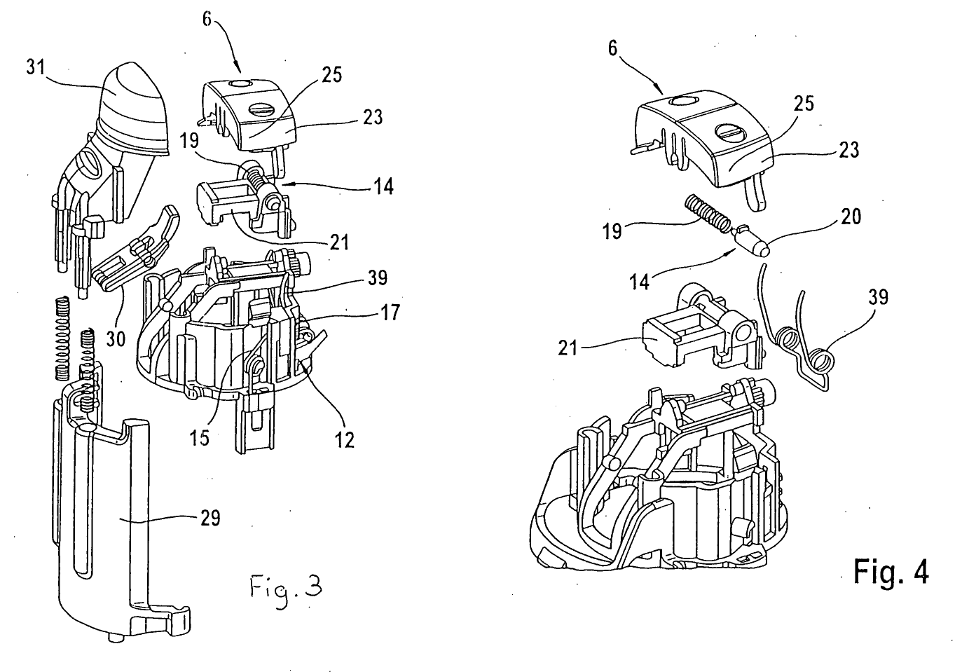

The components illustrated in FIGS. 3 to 6 of the embodiment are generally arranged in the upper region of the electric motor 7 adjacent to the section facing away from the gear 8. In this case, the sliding part 29 is realized and arranged, such that it partially encompasses the essentially cylindrical motor housing. According to FIGS. 3 to 6, an actuating element 6 for opening and closing the switch 12 (FIG. 3) is arranged, for example, in an opening of the housing 2. The switch 12 serves for switching the electric motor 7 on and off. The switch 12 can be operated in either the temporary mode is 5 or the continuous mode depending on the type of the respective attachment coupled to the appliance, i.e., either the kneading hook or the whisks 10 or the immersion blender 11 with its knife.

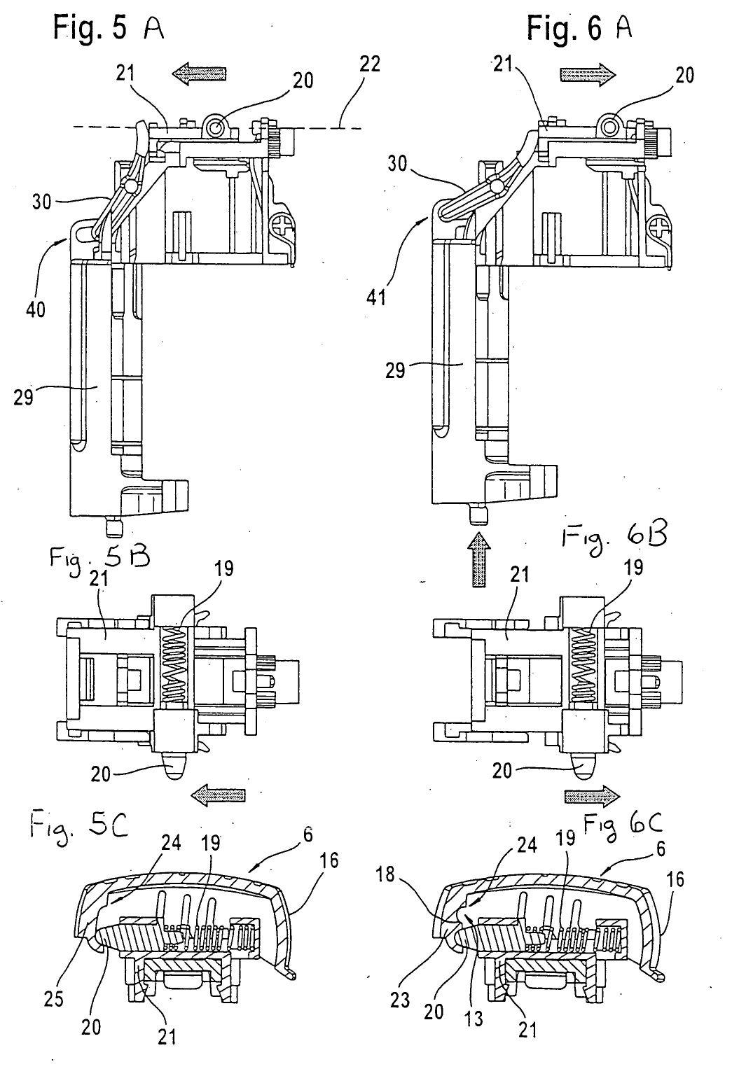

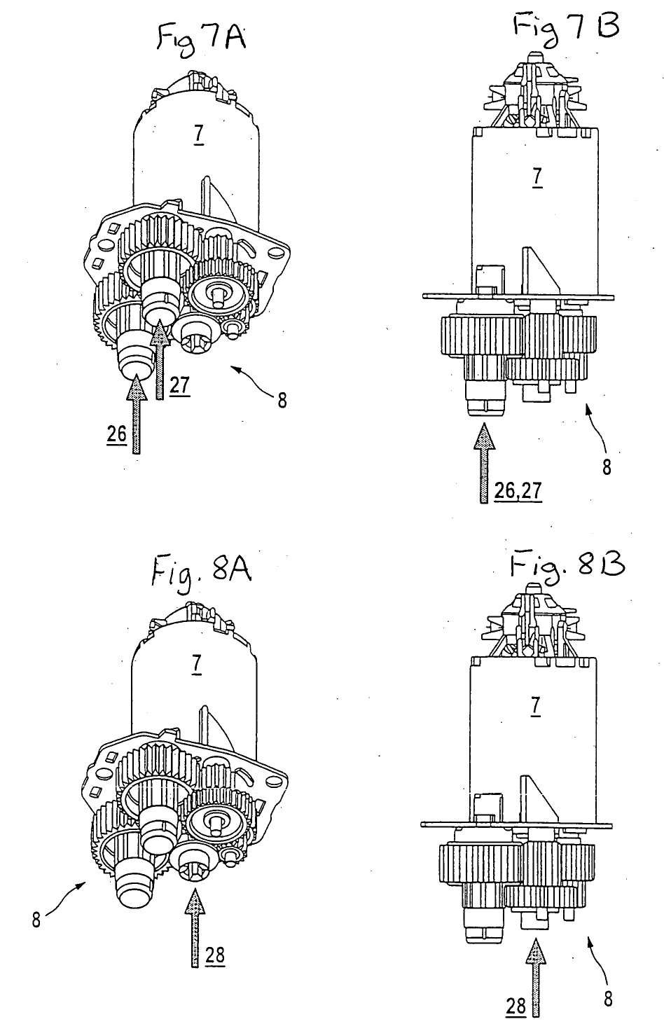

To this end, an interlocking means 13 (FIG. 6C) is provided for the actuating element 6 of the switch 12. This interlocking means is either engaged with a counterpart 14 to the interlocking means (FIG. 6C) or not (FIG. 5C) depending on the type of attachment 10, 11 coupled to the appliance. For example, FIG. 3 shows that the actuating element 6 is subjected to a prestress 15 that can be realized, for example, with an electric contact of the switch 12. This prestress 15 tends to transfer the actuating element 6 into the open position of the switch 12. In some embodiments, the actuating element 6 is realized in the form of a rocker 16. A pivoting movement of this rocker 16 makes it possible to connect a switching contact 17 of the switch 12, for example an elastic switching contact, with another switching contact in an electrically conductive fashion, such that the electric switch 12 is transferred into the on-position. FIG. 6C, for example, shows that the interlocking means 13 of the actuating element 6 is realized in the form of a groove and/or tongue arrangement 18. The counterpart 14 to the interlocking means could be realized, for example, in the form of a finger 20, a peg, a mandrel, a pin or the like. A prestress 19 acts upon the finger 20 in the direction of the interlocking means 13. If the interlocking means 13 and the corresponding counterpart are engaged with one another, the actuating element 6 can be transferred from the off-position shown in FIG. 6C, into a permanent on-position by pivoting the actuating element on the left side of FIG. 6C downward such that the finger 20 penetrates into the upper free groove of the groove/tongue arrangement 18 and permanently holds the actuating element in this position, switching the switch. 12 into the continuous mode in this case.

For example, FIGS. 5B and 6B clearly show that the counterpart 14 to the interlocking means is supported on a carrier or slide 21 that is subjected to the tension of a spring 39. The carrier or slide 21 can be adjusted or displaced relative to the actuating element 6 and its interlocking means 13, respectively. The actuating element 6 can be pivoted, in particular, about an axis 22 (FIG. 5A), wherein the counterpart 14 to the interlocking means and the slide 21 are respectively displaceable in the direction of the pivoting axis 22. According to FIGS. 3 and 4 as well as 5C and 6C, the interlocking means 13 is arranged on the actuating element 6 by means of a first section 23, for example of an inner wall 24. The first section 23 is followed by a second section 25 without interlocking means 13.

A comparison of FIGS. 5 and 6 shows that the counterpart 14 to the interlocking means can be adjusted relative to the actuating element 6. The interlocking means 13 and the corresponding counterpart 14 engage into one another in one position (FIG. 6C). No interlocking means 13 is assigned to the corresponding counterpart 14 in the other position (FIG. 5C). In the arrangement shown in FIG. 5C, the actuating element 6 and therefore also the switch 12 act as temporary mode switches. The switch 12 is automatically transferred into the open position when the actuating element 6 is released.

The various attachments 10, 11 can be inserted into different openings 26, 27; 28 of the housing 2, for example adjacent openings, and driven by the electric motor 7, and if required, via the gear 8. An adjustable sliding part 29 is assigned to at least one of the openings 26, 27 as indicated, for example, in FIGS. 5A, 6A and 3. When coupling the corresponding attachments 10, 11 to the appliance, this sliding part is transferred from the position shown in FIG. 5 into the position shown in FIG. 6, i.e., the sliding part in FIG. 6A is displaced upward in comparison with the sliding part in FIG. 5A. A shaft end of the respective attachment 10 comes in contact with a stop of the sliding part 29 and then slightly displaces the sliding part 29. The sliding part 29 can be displaced, from an initial position 40 shown in FIG. 5a into an end position 41 shown in FIG. 6A, if the corresponding attachment 10 is coupled to the hand-held mixer 1 via the assigned openings 26, 27.

FIGS. 3, 5, 6a also show that the sliding part 29 is kinematically coupled to the counterpart 14 to the interlocking means. A lever 30, for example a rocker-type lever, is arranged between the sliding part 29 and the counterpart 14 to the interlocking means or the carrier or slide 21, respectively. An upward movement of the sliding part 29 according to FIGS. 5A and 6A is converted into a horizontal displacement of the slide 21 and the counterpart 14 to the interlocking means by means of the lever 30, as indicated by means of arrows shaded in gray in FIGS. 5A and 6A, and 5B and 6B. These figures also show that the adjusting devices of the sliding part 29 and the counterpart 14 to the interlocking means, in some embodiments, form an angle of approximately 90°. In other embodiments, the angle may also have a different value, in which case the lever 30 is adapted accordingly.

The sliding part 29 can be transferred from the end position 41 into the initial position 40, by means of an ejector button 31 (FIG. 3). This is achieved by pressing the ejector button 31 according to FIG. 3 downward. An elastic means can be arranged between the ejector button 31 and the sliding part 29 as illustrated in FIG. 3. When the ejector button 31 is actuated and the corresponding attachment is decoupled from the hand-held mixer 1, the sliding part 29 according to FIGS. 3 and 5 once again moves downward, and the slide 21 and the counterpart 14 to the interlocking means are accordingly displaced horizontally toward the left as shown in FIGS. 5A and 5B. As a result, the interlocking means 13 is disengaged from the corresponding counterpart 14 and the actuating element 6 and the switch 12 can be respectively operated in the temporary mode only, i.e., the user needs to permanently hold the actuating element 6 in the respective position, for example, with a finger of one hand.

FIG. 3 shows that the ejector button 31 is essentially arranged directly adjacent to the actuating element 6 and protrudes farther from the housing 2 than the actuating element 6. If the user accidentally drops the appliance and the switch of the appliance hits, for example, the top of the table or the floor, this arrangement ensures that the ejector button 31 is initially activated such that the corresponding attachments 10 are ejected, and that the actuating element 6 is transferred into the temporary mode such that the hand-held mixer 1 is automatically switched off. The arrangement for distinguishing between the attachments, particularly two whisks 10 arranged in the openings 26, 27 and the immersion blender 11 arranged in the opening 28, is schematically illustrated in FIGS. 7 and 8. FIGS. 7B and 8B show that the interlocking means 13 and the corresponding counterpart 14, as well as the actuating element 6, are arranged in the upper region of the electric motor 7.

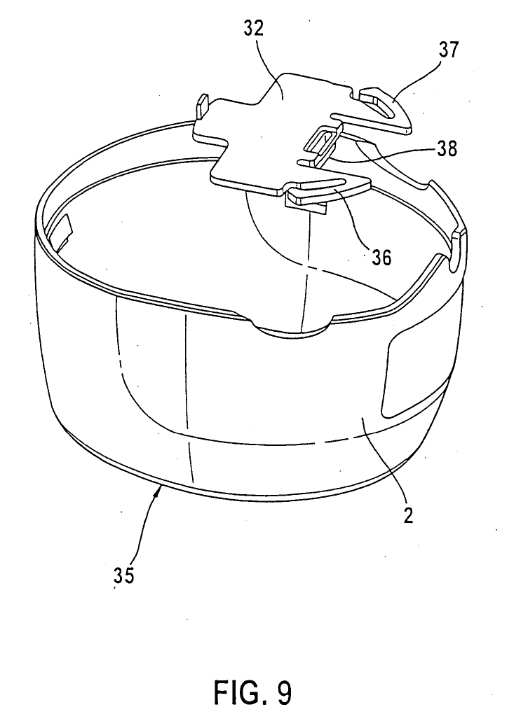

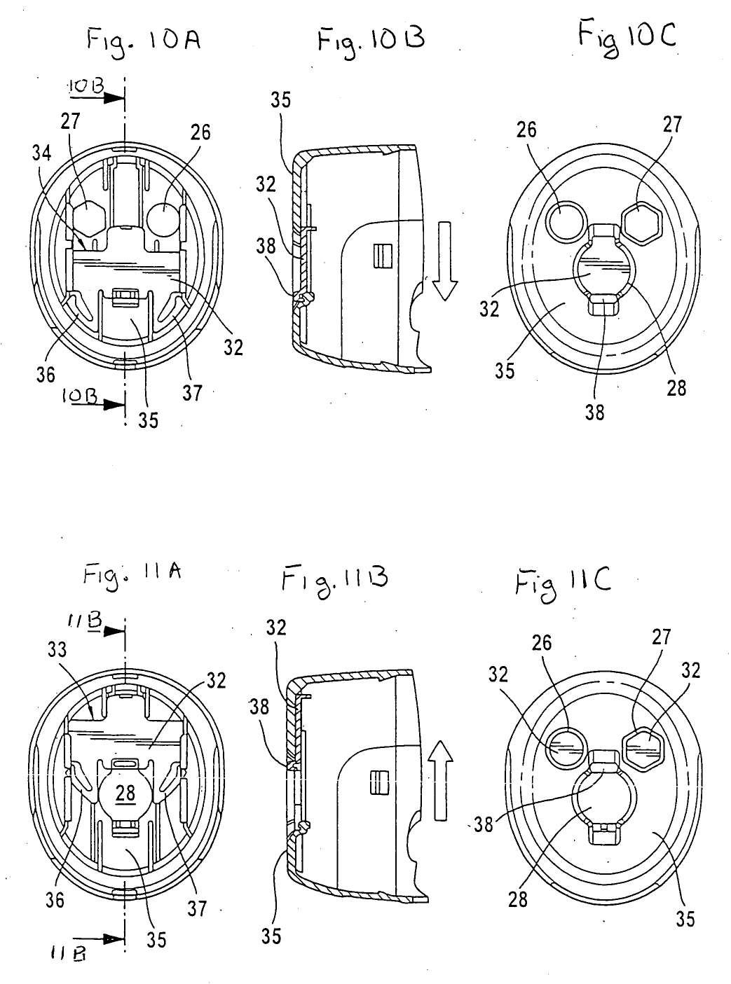

FIGS. 9, 10 and 11 show that the various openings 26, 27, and 28 in the housing 2 that serve for coupling various attachments 10, 11 to the appliance can be selectively closed by means of a sliding plate 32. In this case, the sliding plate 32 can be adjusted between a first end position 33 (FIG. 11) and a second end position 34 (FIG. 10). Either one or more openings 26, 27 for one of the attachments 10 or the other opening 28 for the other attachment 11 is/are closed in the two end positions. According to FIGS. 10A and 11A, the sliding plate 32 is displaceably supported on a housing bottom 35, for example on an inner wall of the bottom. The sliding plate 32 also features elastic arms 36, 37 that engage with corresponding counterparts on the housing bottom 35 in order to fix the sliding plate in the end positions 33, 34. The user is also able to adjust the sliding plate 30 between the end position 33, 34 by means of a protruding handle 38, depending on the attachments 10, 11 to be coupled to the hand-held mixer 1. Due to these measures, it is ensured that the respectively unused openings 26, 27 or 28 are closed by the sliding plate 32 while the respective other opening 28 or 26, 27 is covered by the attachments 10, 11. This ensures that it is very difficult or even impossible for moisture and dust as well as other particles to be admitted into the interior of the housing 2 of the hand-held mixer 1.

A number of embodiments of the invention have been described. Nevertheless, it will be understood that various modifications may be made without departing from the spirit and scope of the invention. For example, other configurations of the interlocking means and its counterpart can be used. Accordingly, other embodiments are within the scope of the following claims.

What is claimed is:

1. A hand-held blender or mixer comprising:
a housing;
an electric motor disposed within the housing and configured to selectively drive different attachments;
a switch that turns the electric motor on when the switch is closed and off when the switch is open, the switch being operable to turn on the motor in either a temporary mode or in a continuous mode, depending upon the respective attachment coupled to the blender or mixer;
a manipulable actuator element operable to selectively open and close the switch; and
an actuator element interlock that is engaged in response to coupling of a selected attachment to the motor, causing operation of the actuator element to turn on the motor in the continuous mode.

2. The mixer or blender according to claim 1, wherein the actuating element is subjected to a prestress that tends to transfer the actuating element into the open position of the switch.

3. The mixer or blender according to claim 1, wherein the actuating element comprises a rocker that actuates a switching contact of the switch.

4. The mixer or blender according to claim 1, wherein the actuating element interlock comprises a tongue and groove arrangement.

5. The mixer or blender according to claim 1, wherein the interlock comprises a peg, a mandrel, a pin or a similar finger that is subjected to a preload.

6. The mixer or blender according to claim 1, further comprising:
a slide supporting a portion of the interlock; and
a spring applying a tension to the slide, such that the slide can be adjusted or displaced relative to the interlock.

7. The mixer or blender according to claim 1, defining a pivoting axis about which the actuating element can be pivoted, and wherein a portion of the interlock is displaceable along the pivoting axis.

8. The mixer or blender according to claim 1, wherein the actuating element has a wall with a first section defining a portion of the interlock and a second section void of an interlock portion, and wherein a mating portion of the interlock is positioned against the first or second wall section depending on the coupled attachment.

9. The mixer or blender according to claim 1, wherein the housing defines at least two openings of the housing into which various attachments can be inserted to be driven by the electric motor.

10. The mixer or blender according to claim 9, further comprising an adjustable slider associated with at least one of the openings.

11. The mixer or blender according to claim 10, wherein the slider is displaced from an initial position to an end position as long as an attachment is coupled to the motor via the associated opening.

12. The mixer or blender according to claim 10, wherein the slider is kinematically coupled to the interlock, the mixer or blender further comprising a lever arranged between the slider and the interlock.

13. The mixer or blender according to claim 10, wherein the slider and a movable portion of the interlock are displaceable in directions approximately perpendicular to each other.

14. The mixer or blender according to claim 11, further comprising an ejector button operable to displace the slider from its end position toward its initial position.

15. The mixer or blender according to claim 14, wherein the ejector button is arranged directly adjacent to the actuating element and protrudes farther from the housing than the actuating element.

16. A hand-held blender or mixer comprising:
a housing defining at least two openings for receiving selected working attachments;
an electric motor disposed within the housing and configured to selectively drive a received attachment; and
a sliding plate manipulable to selectively close and expose the housing openings.

17. The blender or mixer according to claim 16, wherein the sliding plate is adjustable between a first end position in which only an opening or openings associated with a first attachment are closed, and a second end position in which only an opening or openings associated with a second attachment are closed.

18. The blender or mixer according to claim 16, wherein the housing has a bottom displaceably supporting the sliding plate.

19. The blender or mixer according to claim 18, wherein the sliding plate features elastic interlocking arms that engage the housing bottom in the end positions to secure the sliding plate.

20. The blender or mixer according to claim 19, further comprising a protruding handle manipulable to adjust the sliding plate between the end positions.

21. The blender or mixer according to claim 1 or 16, wherein the housing defines an opening therethrough, the opening sized to accommodate a hand of a user for hand-held operation of the blender or mixer.

22. A hand-held appliance system comprising:
a plurality of interchangeable appliance attachments including a first working attachment and a second working attachment; and
a hand-held appliance to which each of the interchangeable appliance attachments can be selectively attached for performing a related function, the appliance comprising:
a housing;
an electric motor disposed within the housing and configured to selectively drive the respective interchangeable attachments;
a switch that turns the electric motor on when the switch is closed and off when the switch is opened, the switch operable to turn on the motor in either a temporary or a continuous mode, depending upon the respective attachment coupled to the appliance;
a manipulable actuator element operable to selectively open and close the switch; and
an actuator element interlock that is engaged by coupling of the first working attachment to the motor, causing operation of the actuator element to turn on the motor in the continuous mode, and that enables operation of the actuator element to turn on the motor in the temporary mode when the second working attachment is coupled to the motor.
